(19) United States
(12) Patent Application Publication
(10) Pub. No.: US 2025/0309249 A1
(43) Pub. Date: Oct. 2, 2025

(54) NEGATIVE ELECTRODE COMPOSITE MATERIAL AND SOLID-STATE BATTERY

(71) Applicant: HONDA MOTOR CO., LTD., Tokyo (JP)

(72) Inventors: Shodai KATO, Saitama (JP); Wataru SHIMIZU, Saitama (JP); Masataka FURUYAMA, Saitama (JP)

(21) Appl. No.: 19/064,746

(22) Filed: Feb. 27, 2025

(30) Foreign Application Priority Data
Mar. 27, 2024 (JP) 2024-051397

(51) Int. Cl. H01M 4/38; H01M 4/02; H01M 4/62; H01M 10/0562

(52) U.S. Cl. CPC H01M 4/386; H01M 4/623; H01M 10/0562; H01M 2004/027; H01M 2300/0068

(57) ABSTRACT

To blend a specific ionic liquid in the negative electrode composite material. Specifically, the negative electrode composite material includes a negative electrode active material, a solid electrolyte, and an ionic liquid, wherein the negative electrode active material is a silicon-based negative electrode active material, the solid electrolyte is a sulfide-based solid electrolyte, and the ionic liquid includes an anion having a donor number of 9 or less as determined from a half-wave potential of a noble metal.

This application is based on and claims the benefit of priority from Japanese Patent Application No. 2024-051397, filed on 27 Mar. 2024, the content of which is incorporated herein by reference.

### BACKGROUND OF THE INVENTION

### Field of the Invention

The present invention relates to a negative electrode composite material and a solid-state battery using the negative electrode composite material.

### Related Art

In recent years, research and development has been conducted on secondary batteries that contribute to energy efficiency in order to ensure that more people have access to affordable, reliable, sustainable, and advanced energy.

Among secondary batteries, solid-state batteries are attracting attention from the viewpoint of high energy density and high safety against heat. The solid-state battery has, for example, a laminate structure in which a positive electrode layer, a negative electrode layer, and a solid electrolyte layer disposed between the positive electrode layer and the negative electrode layer are laminated (see Patent Document 1).

In a solid-state battery, since ions and electrons are transferred at a solid-solid interface, in order to realize a battery having a long life, it is necessary to maintain an ion conduction path at the solid-solid interface over a long period of time. On the other hand, a high-capacity negative electrode active material such as a silicon-based negative electrode active material has a large volume change ratio due to charge and discharge. Therefore, in the negative electrode material including a high-capacity negative electrode active material, a large volume change repeatedly occurs due to repeated charge and discharge. Then, the ion conduction path at the solid-solid interface which could not follow the repeated volume change disappeared, and as a result, the battery capacity was lowered due to the charge-discharge cycles.

On the other hand, there has been proposed a method of improving bonding properties at the solid-solid interface by blending a binder to improve the electrode robustness (see Patent Document 2). However, since the binder does not have electron and ion conductivity, as the blending amount of the binder is increased, the resistance of the battery increases.

Furthermore, in order to maintain the ion conduction path at a solid-solid interface, a method of blending an ionic liquid into the electrode composite material has been proposed (Patent Document 3). However, in the case of a battery where the solid electrolyte is sulfide-based, since the ionic liquid and the sulfide-based solid electrolyte are reactive to each other, the battery characteristics deteriorate due to the reaction, and the realization of long-life solid-state batteries has not yet been achieved.

Patent Document 1: Japanese Unexamined Patent Application, Publication No. 2009-295446

Patent Document 2: Japanese Unexamined Patent Application, Publication No. 2019-169298

Patent Document 3: Japanese Unexamined Patent Application, Publication No. 2017-168435

### SUMMARY OF THE INVENTION

The present invention has been made in view of the above, and an object of the present invention is to provide a negative electrode composite material for a negative electrode for a solid-state battery and a solid-state battery using the negative electrode composite material, the negative electrode composite material being capable of suppressing disappearance of an ion conduction path resulting from charge and discharge of the solid-state battery, accordingly being capable of suppressing a decrease in capacity resulting from charge-discharge cycles, even when the negative electrode composite material includes a high-capacity negative electrode active material having a large volume change ratio and a sulfide-based solid-state electrolyte which is reactive with an ionic liquid.

In order to achieve the above object, the present inventors have conducted extensive studies. The present inventors have found that when the negative electrode composite material includes a specific ionic liquid, even if the negative electrode composite material includes a high-capacity negative electrode active material having a large volume change ratio and a sulfide-based solid electrolyte which is reactive with the ionic liquid, disappearance of an ion conduction path resulting from charge and discharge is suppressed, and as a result, a solid-state battery in which a decrease in capacity resulting from charge-discharge cycles is suppressed can be obtained, having completed the present invention.

That is, the present invention includes the following aspects. A first aspect of the present invention relates to a negative electrode composite material including a negative electrode active material, a solid electrolyte, and an ionic liquid, in which the negative electrode active material is a silicon-based negative electrode active material, the solid electrolyte is a sulfide-based solid electrolyte, the ionic liquid includes an anion having a donor number of 9 or less as determined from a half-wave potential of a noble metal, and the noble metal is at least one selected from the group consisting of Eu^{III/II}, Yb^{III/II}, and Sm^{III/II}. A second aspect of the present invention relates to the negative electrode composite material as described in the first aspect, in which the content of the ionic liquid is 10 mass % or less with respect to a total amount of the negative electrode composite material. A third aspect of the present invention relates to the negative electrode composite material as described in the first or second aspect, in which the ionic liquid is a liquid under an environment of 25° C. A fourth aspect of the present invention relates to the negative electrode composite material as described in any one of the first to third aspects, in which the anion is bis(trifluoromethanesulfonyl)imide (TFSI). A fifth aspect of the present invention relates to the negative electrode composite material as described in any one of the first to fourth aspects, in which the ionic liquid is at least one selected from the group consisting of BMPTFSI, MPPTFSI, EMITFSI, BMITFSI, MOEMPTFSI, PP13TFSI, DEMETFSI, [Li(G2)]TFSI, [Li(G3)]TFSI, [Li(G4)]TFSI, [Li(G5)]TFSI, and [Li(SL)₂]TFSI. A sixth aspect of the present invention relates to the negative electrode composite material as described in any one of the first to fifth aspects, in which the sulfide-based solid electrolyte is an LPS-based solid electrolyte. A seventh aspect of the present invention relates to the negative electrode composite material as described in any one of the first to sixth aspects, further including at least one binder selected from the group consisting of a styrene-butadiene rubber, polyvinylidene fluoride, polytetrafluoroethylene, and a polyimide resin. An eighth aspect of the present invention relates to a solid-state battery including: a positive electrode active material layer; a negative electrode active material layer; and a solid electrolyte layer disposed between the positive electrode active material layer and the negative electrode active material layer, in which the negative electrode active material layer includes the negative electrode composite material as described in any one of the first to seventh aspects.

The negative electrode composite material of the present invention can suppress disappearance of an ion conduction path resulting from charge and discharge, even when including a silicon-based negative electrode active material having a large volume change ratio and a sulfide-based solid electrolyte, thus realizing a solid-state battery in which a decrease in the capacity resulting from charge-discharge cycles is suppressed.

### BRIEF DESCRIPTION OF THE DRAWINGS

FIG. 1 is a graph showing initial charge/discharge curves of the solid-state batteries of Example 1 and Comparative Example 1;

FIG. 2 is a graph showing initial discharge capacities of the solid-state batteries of Example 1 and Comparative Example 1;

FIG. 3 is an explanatory diagram for identifying various initial resistances from a Nyquist plot;

FIG. 4 is a Nyquist plot of the solid-state batteries of Example 1 and Comparative Example 1;

FIG. 5 is a graph showing various initial resistances of the solid-state batteries of Example 1 and Comparative Example 1;

FIG. 6 is a graph showing the capacities of the solid-state batteries of Example 1 and Comparative Example 1; and

FIG. 7 is a graph showing capacity retention ratios of the solid-state batteries of Example 1 and Comparative Example 1.

### DETAILED DESCRIPTION OF THE INVENTION

### Negative Electrode Composite Material

The negative electrode composite material of the present disclosure includes a negative electrode active material, a solid electrolyte, and an ionic liquid. Hereinafter, the negative electrode composite material of the present disclosure will be described for each configuration.

### Negative Electrode Active Material

The negative electrode composite material of the present disclosure includes a silicon-based negative electrode active material as the negative electrode active material. A solid-state battery produced using the silicon-based negative electrode active material exhibits a battery physical property with high capacity. However, the silicon-based negative electrode active material is known to expand during charging, and produces a negative electrode having a large volume change ratio due to charging and discharging. Therefore, in conventional negative electrode composite materials, the ion conduction path disappeared as charge and discharge were repeated, which incurred insufficient achievement of desired battery characteristics, inducing a decrease in the cycle life.

However, according to the negative electrode composite material of the present disclosure, even when the silicon-based negative electrode active material is included, disappearance of the ion conduction path due to charge and discharge is suppressed by including a specific ionic liquid, and thus it is possible to realize a solid-state battery in which a decrease in capacity due to charge-discharge cycles is suppressed.

The silicon-based negative electrode active material to be used in the negative electrode composite material of the present disclosure is not particularly limited as long as silicon (Si) is contained as a constituent element. As the silicon-based negative electrode active material, materials known as the negative electrode active material of a solid-state battery can be used. Examples of the silicon-based negative electrode active material include Si, Si alloys, and silicon oxides, and in the present disclosure, not only one type but also two or more types may be used in combination.

The shape of the silicon-based negative electrode active material is not particularly limited, and may be a general shape, that is, a particulate shape. The silicon-based negative electrode active material may be in the form of primary particles or secondary particles. An average particle diameter (D50) of the silicon-based negative electrode active material is not particularly limited, and may be, for example, 0.01 μm or more and 10 μm or less.

The content of the silicon-based negative electrode active material with respect to the entire negative electrode composite material is not particularly limited, and may be appropriately determined according to the desired performance of the battery of interest. For example, the content of the silicon-based negative electrode active material with respect to the entire negative electrode composite material may be 30% by mass or more and 90% by mass or less, and preferably 50% by mass or more and 80% by mass or less.

Note that it is sufficient for the negative electrode composite material of the present disclosure to contain the silicon-based negative electrode active material as an essential active material, and the negative electrode composite material of the present disclosure may contain a negative electrode active material other than the silicon-based negative electrode active material in addition to the silicon-based negative electrode active material. Examples of the negative electrode active material other than the silicon-based negative electrode active material include carbon materials such as graphite and hard carbon, various oxides such as lithium titanate, and various metals such as metallic lithium and lithium alloys.

From the viewpoint of achieving more remarkable effects, the content of the silicon-based negative electrode active material with respect to the entire negative electrode active material contained in the negative electrode composite material is preferably 90% by mass or more, more preferably 95% by mass or more, and most preferably 99% by mass or more. Particularly preferably, the negative electrode active material contained in the negative electrode composite material of the present disclosure contains 100% by mass of the silicon-based active material.

### Solid Electrolyte

The negative electrode composite material of the present disclosure includes a sulfide-based solid electrolyte as the solid electrolyte. The sulfide-based solid electrolyte is not particularly limited as long as the sulfide-based solid electrolyte contains a metal element (M) serving as a conducting ion and sulfur(S), and has ion conductivity of a metal belonging to Group 1 or 2 of the periodic table.

Examples of the metal element (M) of the sulfide-based solid electrolyte include Li, Na, K, Mg, Ca, or the like and among them, Li is preferable.

Furthermore, the sulfide-based solid electrolyte preferably contains Li, A (A is at least one selected from the group consisting of P, Si, Ge, Al, and B), and S. Among them, A is preferably P (phosphorus) from the viewpoint of ion conductivity, that is, the sulfide-based solid electrolyte contained in the negative electrode composite material of the present disclosure is preferably an LPS-based solid electrolyte.

Further, the sulfide-based solid electrolyte may contain halogen such as Cl, Br, I, or the like. When the sulfide-based solid electrolyte contains halogen, ion conductivity is improved. The sulfide-based solid electrolyte may contain oxygen (O).

Examples of the sulfide-based solid electrolyte having Li ion conductivity include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, and Z is any of Ge, Zn, or Ga), Li₂S—GeS₂, Li₂S—SiS₂—Li₃PO₄, Li₂S—SiS₂—LiₓMO_{y} (x and y are positive numbers, and M is any one of P, Si, Ge, B, Al, Ga, or In), etc. The above description of “Li₂S—P₂S₅” means a sulfide-based solid electrolyte produced using a raw material composition containing Li₂S and P₂S₅, and the same applies to the other descriptions.

In the negative electrode composite material of the present disclosure, the sulfide-based solid electrolyte may be used not only alone but also in combination of two or more types thereof.

The form of the solid electrolyte material is not particularly limited, and may be, for example, a particulate form.

The content of the sulfide-based solid electrolyte with respect to the entire negative electrode composite material is not particularly limited, and may be appropriately decided in accordance with the desired performance of the battery of interest. For example, the content of the sulfide-based solid electrolyte with respect to the entire negative electrode composite material may be 10% by mass or more and 70% by mass or less, and preferably 20% by mass or more and 50% by mass or less.

Note that it is sufficient for the negative electrode composite material of the present disclosure to contain the sulfide-based solid electrolyte as an essential solid electrolyte, and the negative electrode composite material of the present disclosure may contain a solid electrolyte other than the sulfide-based solid electrolyte in addition to the sulfide-based solid electrolyte. Examples of the solid electrolyte other than the sulfide-based solid electrolyte include an oxide solid electrolyte material, a halide solid electrolyte, an inorganic solid electrolyte such as a lithium-containing salt, a polymer-based solid electrolyte such as polyethylene oxide, a gel-based solid electrolyte containing a lithium-containing salt or a lithium ion conductive ionic liquid, and the like.

From the viewpoint of exhibiting more remarkable effects, the content of the sulfide-based solid electrolyte with respect to the entire solid electrolyte contained in the negative electrode composite material is preferably 90% by mass or more, more preferably 95% by mass or more, and most preferably 99% by mass or more. Particularly preferably, the solid electrolyte included in the negative electrode composite material of the present disclosure contains 100 mass % of the sulfide-based solid electrolyte.

### Ionic Liquid

The negative electrode composite material of the present disclosure includes an ionic liquid. Ionic liquids can be classified into 1) aprotic ionic liquids, 2) protic ionic liquids, 3) inorganic ionic liquids, and 4) solvated ionic liquids.

1) to 3) consist of only a cation and an anion, and 4) is in a form containing a neutral molecule, such as glyme or sulfolane. The ionic liquid contained in the negative electrode composite material of the present disclosure may be any of the ionic liquids in the forms of 1) to 4) described above.

Since the ionic liquid has high ion conductivity, when the negative electrode composite material contains the ionic liquid, an increase in resistance of the obtained solid-state battery can be suppressed. Since the ionic liquid has high viscosity, the ionic liquid can follow the volume change of the active material. Thus, even when the solid-solid interface is peeled off, the ion conduction path can be maintained by the presence of the ionic liquid.
1) Examples of the aprotic ionic liquid include EMITFSI.
2) Examples of the protic ionic liquid include DEMATFSI.
3) Examples of the inorganic ionic liquid include LiFSI_{0.45}—KFSI_{0.55}.
4) Examples of the solvated ionic liquid include [Li(G4)]TFSI.

The ionic liquid contained in the negative electrode composite material of the present disclosure includes an anion having a donor number of 9 or less, the donor number being obtained from a half-wave potential of a noble metal. As used herein, the noble metal as a target of the half-wave potential, the donor number of which is to be determined, is at least one selected from the group consisting of Eu^{III/II}, Yb^{III/II}, and Sm^{III/II}.

As described above, the negative electrode composite material of the present disclosure contains a sulfide-based solid electrolyte. Since an ionic liquid containing an anion having a donor number of more than 9 has high reactivity with the sulfide-based solid electrolyte, when such an ionic liquid is used together with the sulfide-based solid electrolyte, the capacity decreases with charge-discharge cycles. Since the negative electrode composite material of the present disclosure contains an ionic liquid containing an anion having a donor number of 9 or less obtained from a half-wave potential of the noble metal, that is, the ionic liquid having high ion conductivity and low electron donating property is blended, it is possible to realize a solid-state battery in which a decrease in capacity resulting from charge-discharge cycles is suppressed.

In the present description, a method for measuring the donor number obtained from the half-wave potential of a noble metal is as follows: an electrolytic solution is prepared by dissolving a salt of the noble metal in an ionic liquid; a cell is manufactured together with a working electrode, a counter electrode and a reference electrode; a half-wave potential is obtained from a peak potential of a differential pulse voltammogram; and extrapolating the obtained half-wave potential in an approximate straight line of a plot of half-wave potentials of noble metals with respect to known donor numbers of organic solvents. In this case, the working electrode and the counter electrode are preferably made of a material inert to the oxidation-reduction reaction of the noble metal, such as platinum or glassy carbon, and the working electrode is preferably disc-shaped and has a larger surface area than the working electrode. As the reference electrode, a reference electrode that utilizes an equilibrium reaction of Ag/Ag(I) is preferable and a reference electrode that can convert potential at the time of extrapolation to a ferrocene/ferrocenium reference will suffice. The approximate straight line of the half-wave potentials of noble metals with respect to the donor numbers is prepared by using, as reference data, the half-wave potentials of Eu^{III/II}, Yb^{III/II}, and Sm^{III/II}, in benzonitrile, acetonitrile, propanediol-1,2-carbonate, trimethyl phosphate, N,N-dimethylformamide, N,N-dimethylacetamide, and dimethyl sulfoxide as solvents.

The ionic liquid contained in the negative electrode composite material of the present disclosure is preferably liquid under an environment of 25° C. When the ionic liquid is liquid under a 25° C. environment (room temperature), the negative electrode formed from the negative electrode composite material of the present disclosure has a high ionic conductivity in the 25° C. environment (room temperature).

An anion of the ionic liquid containing an anion having a donor number of 9 or less obtained from the half-wave potential of the noble metal used in the negative electrode composite material of the present disclosure is preferably bis(trifluoromethanesulfonyl)imide (TFSI) represented by the following formula (1). Therefore, the ionic liquid containing an anion having a donor number of 9 or less obtained from the half-wave potential of the noble metal used in the negative electrode composite material of the present disclosure is preferably a TFSI-based ionic liquid or a TFSI-based solvated ionic liquid.

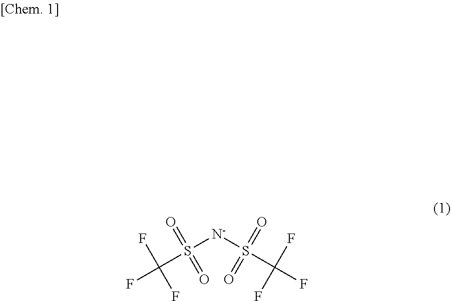 [SMILES: O=S(=O)([N-]S(=O)(=O)C(F)(F)F)C(F)(F)F]

Further, the ionic liquid used in the negative electrode composite material of the present disclosure is preferably at least one selected from the group consisting of BMPTFSI, MPPTFSI, EMITFSI, BMITFSI, MOEMPTFSI, PP13TFSI, DEMETFSI, [Li(G2)]TFSI, [Li(G3)]TFSI, [Li(G4)]TFSI, [Li(G5)]TFSI, and [Li(SL)2]TFSI.

The ionic liquid to be used in the negative electrode composite material of the present disclosure is more preferably an aprotic ionic liquid, still more preferably an ionic liquid consisting of a pyrrolidinium-based cation and TFSI-, and particularly preferably BMPTFSI.

In the negative electrode composite material of the present disclosure, the content of the ionic liquid is preferably 10% by mass or less with respect to the total amount of the negative electrode composite material. With the ionic liquid described above, the effects of the present invention can be sufficiently exhibited even when the ionic liquid is blended in a small amount.

In the negative electrode composite material of the present disclosure, the content of the ionic liquid may be 1% by mass or more with respect to the total amount of the negative electrode composite material. On the other hand, the content of the ionic liquid may be 10% by mass or less and may be 5% by mass or less, with respect to the total amount of the negative electrode composite material.

### Other Components

The negative electrode composite material of the present disclosure may optionally contain other components in addition to the negative electrode active material, the solid electrolyte, and the ionic liquid, which are essential components. The other component may be any known substance that can be blended in negative electrode composite materials of solid-state batteries. Examples of the other components include a binder and a conductive material.

### Binder

As the binder that can be blended in the negative electrode composite material of the present disclosure, a substance known as a binder for solid batteries can be applied. Due to the presence of the binder, the negative electrode obtained from the negative electrode material of the present disclosure has improved bonding properties at the solid-solid interface, which improves electrode robustness, enabling the effects of the present invention at a higher level.

Preferably, the binder that can be blended in the negative electrode composite material of the present disclosure is at least one selected from the group consisting of a styrene-butadiene rubber, polyvinylidene fluoride, polytetrafluoroethylene, and a polyimide resin.

### Solid-State Battery

The solid-state battery of the present disclosure is a solid-state battery including a positive electrode active material layer, a negative electrode active material layer, and a solid electrolyte layer disposed between the positive electrode active material layer and the negative electrode active material layer, in which the negative electrode active material layer includes the negative electrode composite material of the present disclosure described above.

The solid-state battery of the present disclosure may include other layers as long as the solid-state battery includes the positive electrode active material layer, the negative electrode active material layer, and the solid electrolyte layer as essential constituent layers. Examples of the other layers include a positive electrode current collector, a negative electrode current collector, etc.

Hereinafter, the solid-state battery of the present disclosure will be described for each configuration.

### Positive Electrode Active Material Layer

The positive electrode active material layer is a layer containing at least a positive electrode active material. The positive electrode active material contained in the positive electrode active material layer is not particularly limited as long as it is used in a positive electrode active material layer of a general solid-state battery. Examples of the positive electrode active material include a lithium-containing layered active material, a spinel active material, and an olivine active material, for example, in the case of a lithium ion battery. Specific examples of the positive electrode active material include lithium cobaltate (LiCoO₂), lithium nickelate (LiNiO₂), LiNiₚMn_{q}CoᵣO₂ (p+q+r=1), LiNiₚAl_{q}COᵣO_{z} (p+q+r=1), lithium manganate (LiMn₂O₄), hetero element-substituted Li—Mn spinel represented by Li₁₊ₓMn_{2-x-y}M_{y}O₄ (x+y=2, M=at least one selected from Al, Mg, Co, Fe, Ni, or Zn), lithium titanate (an oxide containing Li and Ti), and lithium metal phosphate (LiMPO₄, M=at least one selected from Fe, Mn, Co, or Ni).

The content of the positive electrode active material in the positive electrode active material layer may be, for example, in the range of 50% by mass to 99% by mass. The surface of the positive electrode active material may be coated with an oxide layer such as a lithium niobate layer, a lithium titanate layer, or a lithium phosphate layer.

The positive electrode active material layer may optionally contain a solid electrolyte to be described later for the purpose of improving lithium ion conductivity. The positive electrode active material layer may optionally contain a binder, a conductive aid, or the like. As these materials, those generally used in solid batteries can be used.

The method for producing the positive electrode active material layer is not particularly limited, and the positive electrode active material layer can be produced by a known method. The positive electrode active material layer can be produced, for example, by mixing a material to constitute the positive electrode active material layer together with a solvent to form a slurry, applying the slurry to a positive electrode current collector, and drying the slurry.

The thickness of the positive electrode active material layer is not particularly limited, and can be appropriately decided according to the desired performance of the battery. The thickness of the positive electrode active material layer may be, for example, 0.1 μm or more and 1 mm or less.

### Negative Electrode Active Material Layer

The negative electrode active material layer in the solid-state battery of the present disclosure is obtained from the negative electrode composite material of the present disclosure described above.

### Method for Producing Negative Electrode Active Material Layer

The method for producing the negative electrode active material layer in the solid-state battery of the present disclosure from the negative electrode composite material of the present disclosure is not particularly limited. A known method of forming a negative electrode active material layer using a negative electrode composite material can be applied.

For example, the negative electrode active material layer can be formed on at least one surface of the negative electrode current collector by preparing a slurry in which the negative electrode composite material of the present disclosure is dispersed and/or dissolved in a solvent, applying the slurry to the at least one surface of the negative electrode current collector, drying the slurry, and optionally pressing the negative electrode current collector. In addition, the thickness of the negative electrode active material layer can be easily adjusted by adjusting a coating amount or the like of the slurry.

The thickness of the negative electrode active material layer is not particularly limited, and can be appropriately decided according to the desired performance of the battery. The thickness of the negative electrode active material layer may be, for example, 0.1 μm or more and 1 mm or less.

### Solid Electrolyte Layer

The solid electrolyte layer is a layer containing a solid electrolyte. The solid electrolyte layer is disposed between the positive electrode active material layer and the negative electrode active material layer.

A material of the solid electrolyte is not particularly limited as long as it has ion conductivity and insulation properties, such as lithium. As the material of the solid electrolyte, a known material used in solid batteries can be used.

Examples of the material of the solid electrolyte include a sulfide solid electrolyte material, an oxide solid electrolyte material, a halide solid electrolyte, an inorganic solid electrolyte such as a lithium-containing salt, a polymer-based solid electrolyte such as polyethylene oxide, and a gel-based solid electrolyte which contains a lithium-containing salt or a lithium ion conductive ionic liquid, and the like. Among them, a sulfide solid electrolyte material is preferable from the viewpoint of high electrical conductivity and good structure moldability and interfacial bonding properties by pressing.

The form of the solid electrolyte material is not particularly limited, and may be, for example, a particulate form. In the solid electrolyte layer of the solid-state battery of the present disclosure, the content of the solid electrolyte is not particularly limited. The content of the solid electrolyte may be, for example, in the range of 50% by mass to 99% by mass.

The solid electrolyte layer may optionally include a binder. For the purpose of imparting mechanical strength and flexibility, an adhesive may be optionally contained. As these materials, those generally used in solid batteries can be used.

The method for producing the solid electrolyte layer is not particularly limited, and the solid electrolyte layer can be produced by a known method. The solid electrolyte layer can be produced, for example, by mixing a material to constitute the solid electrolyte layer together with a solvent to form a slurry, applying the slurry to a base material, and drying the slurry.

### Positive Electrode Current Collector

The positive electrode current collector, which is an optional constituent element of the solid-state battery of the present disclosure, is disposed in contact with the positive electrode active material layer, and has a function of collecting a current in the positive electrode active material layer. The material of the positive electrode current collector is not particularly limited as long as the positive electrode current collector can collect a current in the positive electrode active material layer. Examples of the material for the positive electrode current collector include aluminum, an aluminum alloy, stainless steel, nickel, iron, titanium, etc. and among them, at least one selected from the group consisting of aluminum, an aluminum alloy, and stainless steel is preferable.

The shape of the positive electrode current collector is not particularly limited, and examples thereof include a foil shape and a plate shape. The thickness of the positive electrode current collector is not particularly limited, and may be the same as that used for a positive electrode of a general solid-state battery. The thickness of the positive electrode current collector may be, for example, 0.1 μm or more and 1 mm or less.

### Negative Electrode Current Collector

The negative electrode current collector used in the solid-state battery of the present disclosure is disposed in contact with the negative electrode active material layer, and has a function of collecting a current of the negative electrode active material layer. The material of the negative electrode current collector is not particularly limited as long as the negative electrode current collector can collect a current in the negative electrode active material layer, but is preferably formed of a substance having high conductivity. Examples of the substance having high conductivity include a metal containing at least one metal element selected from the group consisting of silver, palladium, gold, platinum, aluminum, copper, and nickel, an alloy such as a stainless steel material, or a non-metal such as carbon (C).

Among these highly conductive substances, in consideration of production cost in addition to high conductivity, it is preferable to use at least one selected from the group consisting of copper, SUS, and nickel. In particular, since the stainless steel material hardly reacts with a negative electrode active material, a positive electrode active material, or a solid electrolyte, if the stainless steel material is used as the material of the negative electrode current collector, internal resistance of the solid-state battery can be reduced.

The shape of the negative electrode current collector is not particularly limited, and examples thereof include a foil shape, a plate shape, a mesh shape, a nonwoven fabric shape, a foamed shape, etc. In addition, the negative electrode current collector may include a carbon layer or the like disposed on the surface thereof or the surface thereof may be roughened for the purpose of enhancing adhesion to the negative electrode active material layer.

The thickness of the negative electrode current collector is not particularly limited, and may be the same as that used for a negative electrode of a general solid-state battery. The thickness of the negative electrode current collector may be, for example, 0.1 μm or more and 1 mm or less.

### Production Method of Solid-State Battery

A method for producing the solid-state battery of the present disclosure is not particularly limited, and a known method can be used. For example, an electrode body is produced by laminating a negative electrode current collector, a negative electrode active material layer, a solid electrolyte layer, a positive electrode active material layer, and a positive electrode current collector in this order. Thereafter, a plurality of electrode bodies are stacked, and are optionally pressed to integrate the electrode bodies to produce an electrode laminate, whereby the solid-state battery of the present disclosure can be obtained.

Although the preferred embodiments of the present invention have been described above, the present invention is not limited to the above-described embodiments, and modifications or improvements within a range capable of achieving the object of the present invention are included in the present invention.

### EXAMPLES

Hereinafter, the present invention will be described in more detail with reference to Examples and the like, but the present invention is not limited to the following Examples and the like.

### Example 1

### Materials

The following were prepared as materials for laminate cells for evaluation.

### Positive Electrode

Positive active material: NMC622 (LiNi_{0.6}Mn_{0.2}Co_{0.2}O₂)
Positive electrode current collector: aluminum foil

### Negative Electrode

Negative electrode active material: Si/C composite active material (Si: 55 mass %)
Solid electrolyte: LPS system-halogen (Cl): Li₇₋ₓPS₆₋ₓClₓ
Ionic liquid: BMPTFSI (1-butyl-3-methylimidazolium bis(trifluoromethanesulfonyl)imide)
Binder: styrene butadiene rubber (SBR)
Negative electrode current collector: copper foil

### Solid Electrolyte

Solid electrolyte: LPS-based-halogen (Cl): Li₇₋ₓPS₆₋ₓClₓ

### Preparation of Negative Electrode Composite Material Paste

A negative electrode composite material paste was obtained by mixing a negative electrode active material, a solid electrolyte, an ionic liquid, and a binder. The content of the negative electrode active material was 70% by mass, the content of the solid electrolyte was 28% by mass, the content of the ionic liquid was 18 by mass, and the content of the binder was 1% by mass.

### Preparation of Solid-State Battery for Evaluation

The positive electrode current collector, the positive electrode active material layer, the solid electrolyte layer, the negative electrode active material layer, and the negative electrode current collector were laminated in this order, and pressed at 25° C. (room temperature) at a molding pressure of 980 MPa for 5 minutes to obtain an electrode body. The obtained electrode body was laminate-sealed and restrained at 1.5 MPa to obtain a solid-state battery for evaluation.

### Comparative Example 1

### Preparation of Solid-State Battery for Evaluation

A laminate cell was produced in the same manner as in Example 1 except that the ionic liquid was not used in the negative electrode composite material.

### Evaluation

### Initial Discharge Capacity

The obtained evaluation battery was aged at 60° C. The aging was performed under the following conditions: the charge condition was 1/100 C rate, the upper limit charge capacity was 175 mAh/g, the discharge condition was 1/10 C rate, and the voltage at the end of discharge was 2.65 V.

Subsequently, the aged solid-state battery was subjected to initial charge and discharge to obtain an initial charge/discharge curve. The initial charge and discharge conditions were 25° C., a 1/10 C rate, a voltage at the end of discharge of 2.65 V, and a voltage at the end of charge of 3.72 V. Thereafter, charging and discharging were performed at the conditions of 25° C., a ⅓ C rate, a voltage at the end of discharging of 2.65 V, and a voltage at the end of charging of 3.72 V.

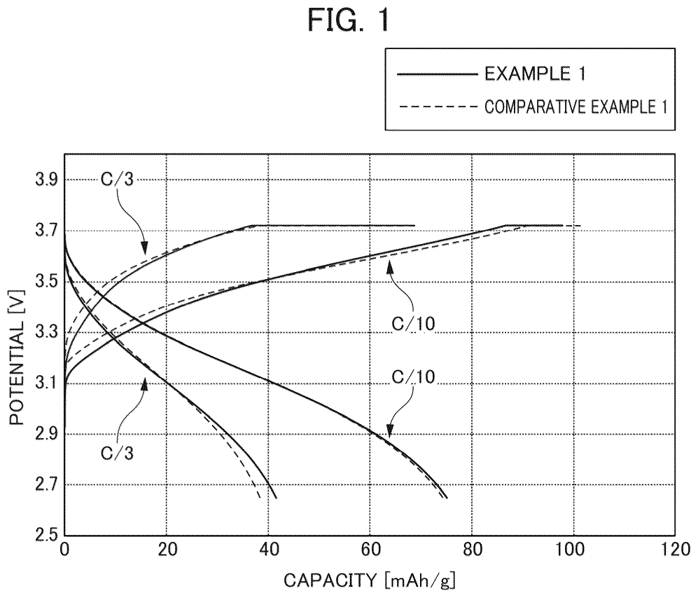

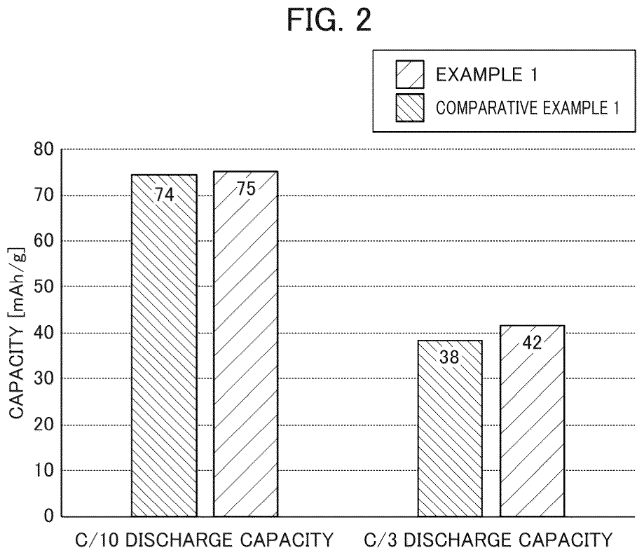

The obtained initial charge/discharge curves of 1/10 C rate and ⅓ C rate are shown in FIG. 1. FIG. 2 shows initial discharge capacities at 1/10 C rate and ⅓ C rate.

### Initial Resistance

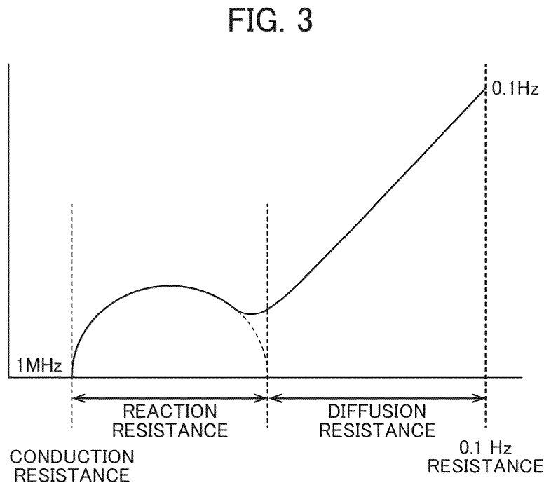

Next, the solid-state battery subjected to the above initial discharge capacity test was subjected to an initial resistance test. The initial resistance test was performed by an AC impedance method. Plotting the impedance at multiple frequencies measured by the AC impedance method yields a Nyquist plot as shown in FIG. 3. Parts appearing in the Nyquist plot are defined as 0.1 Hz resistance, conduction resistance, reaction resistance, and diffusion resistance, as shown in FIG. 3.

The AC impedance measurement was performed using SI1287 (Solartron Analytical) as a measuring instrument. The measurement conditions were a temperature of 25° C., an applied AC voltage of 10 mV, and a frequency of 0.1 Hz to 1 MHz.

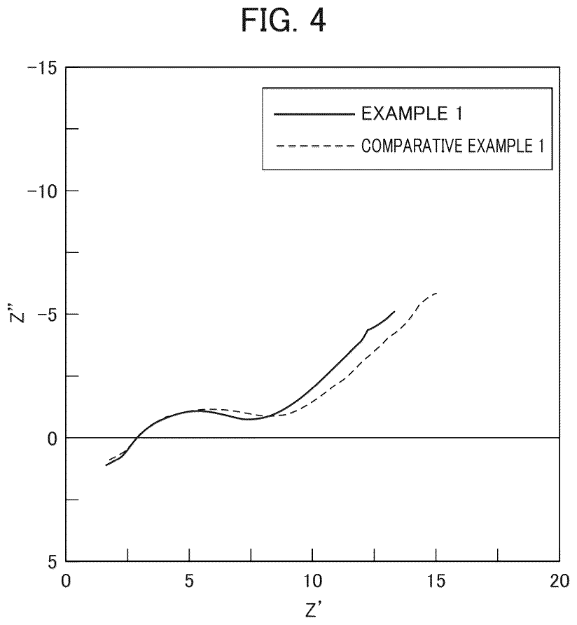

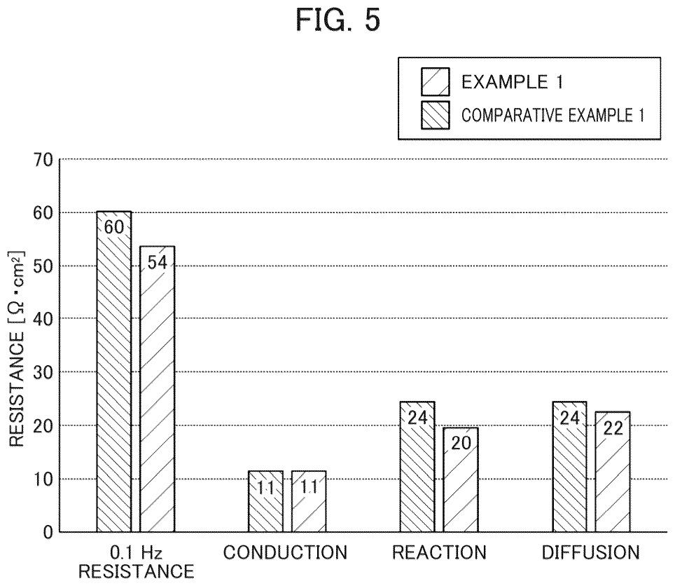

The resulting Nyquist plot is shown in FIG. 4. The 0.1 Hz resistance, the conduction resistance, the reaction resistance, and the diffusion resistance were obtained from the Nyquist plot of FIG. 4. The results are shown in FIG. 5.

### Capacity Retention Ratio

The solid-state battery subjected to the initial resistance test was then subjected to a charge-discharge cycle test under a temperature condition of 60° C. In the charge-discharge cycle test, one cycle was determined as including charge to an upper limit voltage of 4.00 V at a constant current of a current density of 2.0 mA/cm² and then discharge to a discharge lower limit voltage of 2.65 V at a constant current of a current density of 20 mA/cm², and this cycle was performed for 50 cycles in total. Then, the discharge capacity was measured for each cycle.

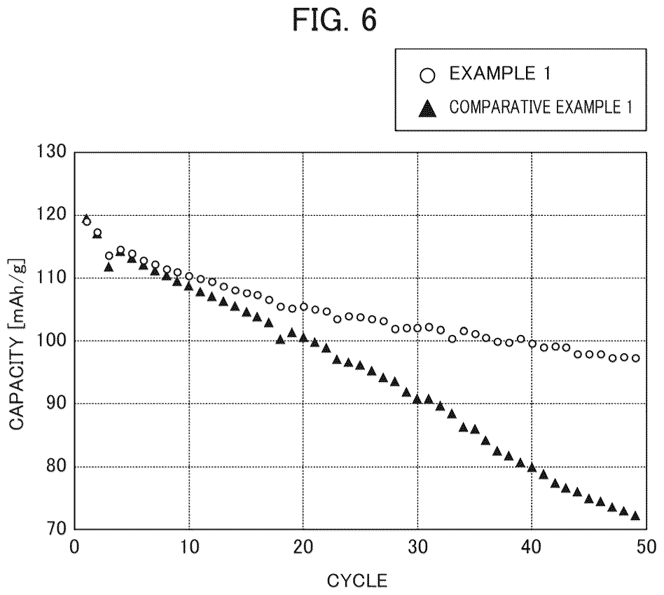

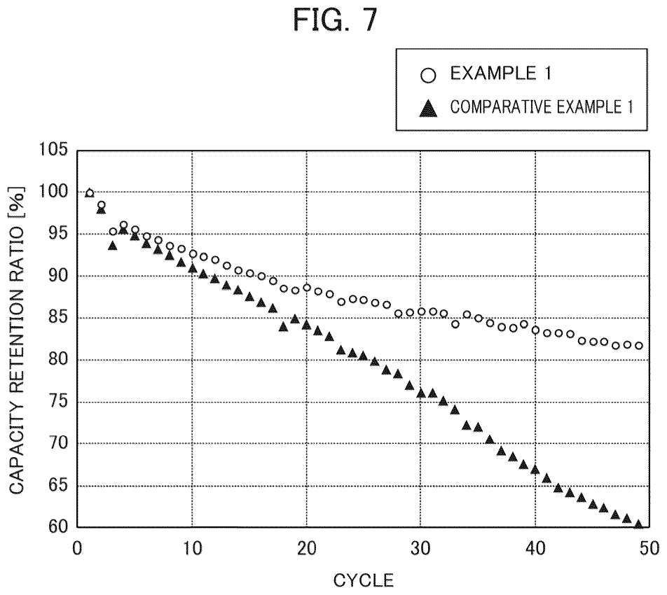

FIG. 6 shows a graph in which the cycle and the discharge capacity are plotted. Assuming that the discharge capacity of the solid-state battery before the cycle test (at the time of 0 cycle) was taken as 100%, the capacity retention ratio in each cycle was obtained. FIG. 7 shows a graph in which the cycle and the capacity retention ratio are plotted.

### Discussions

In the solid-state battery produced in Example 1, the C/3 discharge capacity was improved, and all of the 0.1 Hz resistance, the reaction resistance, and the diffusion resistance were reduced, compared with the solid-state battery produced in Comparative Example 1. In addition, the solid-state battery produced in Example 1 had a higher discharge capacity retention ratio at the time of 50 cycles compared with the solid-state battery produced in Comparative Example 1.

What is claimed is:

1. A negative electrode composite material comprising a negative electrode active material, a solid electrolyte, and an ionic liquid,
wherein the negative electrode active material is a silicon-based negative electrode active material,
the solid electrolyte is a sulfide-based solid electrolyte,
the ionic liquid comprises an anion having a donor number of 9 or less as determined from a half-wave potential of a noble metal,
and the noble metal is at least one selected from the group consisting of Eu^{III/II}, Yb^{III/II}, and Sm^{III/II}.

2. The negative electrode composite material according to claim 1, wherein the content of the ionic liquid is 10 mass % or less with respect to a total amount of the negative electrode composite material.

3. The negative electrode composite material according to claim 1, wherein the ionic liquid is a liquid under an environment of 25° C.

4. The negative electrode composite material according to claim 1, wherein the anion is bis(trifluoromethanesulfonyl)imide (TFSI).

5. The negative electrode composite material according to claim 1, wherein the ionic liquid is at least one selected from the group consisting of BMPTFSI, MPPTFSI, EMITFSI, BMITFSI, MOEMPTFSI, PP13TFSI, DEMETFSI, [Li(G2)]TFSI, [Li(G3)]TFSI, [Li(G4)]TFSI, [Li(G5)]TFSI, and [Li(SL)₂]TFSI.

6. The negative electrode composite material according to claim 1, wherein the sulfide-based solid electrolyte is an LPS-based solid electrolyte.

7. The negative electrode composite material according to claim 1, further comprising at least one binder selected from the group consisting of a styrene-butadiene rubber, polyvinylidene fluoride, polytetrafluoroethylene, and a polyimide resin.

8. A solid-state battery comprising: a positive electrode active material layer; a negative electrode active material layer; and a solid electrolyte layer disposed between the positive electrode active material layer and the negative electrode active material layer,
wherein the negative electrode active material layer comprises the negative electrode composite material according to claim 1.
